(19) United States
(12) Patent Application Publication
(10) Pub. No.: US 2017/0005548 A1
(43) Pub. Date: Jan. 5, 2017

(54) METHOD FOR COOLING AN ELECTRICITY GENERATOR AND DEVICE FOR PERFORMING SAID METHOD

(71) Applicant: LABINAL POWER SYSTEMS, Blagnac (FR)

(72) Inventors: Jacques SALAT, Brie Comte Robert (FR); Jean-Michel CHASTAGNIER, Briis Sous Forges (FR)

(73) Assignee: LABINAL POWER SYSTEMS, Blagnac (FR)

(21) Appl. No.: 15/104,941

(22) PCT Filed: Dec. 9, 2014
(86) PCT No.: PCT/FR2014/053235

§ 371 Date: Jun. 15, 2016

(30) Foreign Application Priority Data
Dec. 16, 2013 (FR) 1362694

(51) Int. Cl. H02K 9/10; B64D 15/12; H02K 1/16; B64C 27/32; H02K 19/38; H02K 1/27

(52) U.S. Cl. CPC H02K 9/10; H02K 19/38; H02K 1/27; H02K 1/16; B64C 27/32; B64D 15/12

(57) ABSTRACT

A method for cooling an electricity generator (50) for delivering electricity to a first rotor (60), the first rotor being suitable for being rotated relative to a stationary structure, the method being characterized in that the electricity generator is placed in a chamber (62) arranged inside the first rotor, and in that it comprises the following steps:
a) transferring heat produced by the generator to a cooling fluid, thereby vaporizing the fluid in an evaporator (64);
b) transporting the vaporized fluid to a condenser; and
c) condensing the fluid in the condenser, the heat delivered by the fluid being transmitted to the air surrounding the condenser.

The invention relates to a device comprising a stationary structure, a first rotor suitable for being rotated relative to the stationary structure, an electricity generator for delivering electricity to the first rotor, and a cooling system for discharging the heat produced by the electricity generator.

The invention applies more particularly when the first rotor is the rotary wing of a helicopter; the cabin of the helicopter then constituting the stationary structure of the device.

In known manner, a helicopter may have a device for de-icing the blades of its rotor. Such a device usually comprises a set of resistance elements arranged in the blades.

The resistance elements are usually powered electrically via a set of rotary collectors situated between the rotary wing (the first rotor) and the cabin (the stationary structure) of the helicopter.

The electricity powering the resistances may be generated by a dedicated generator. The generator is a generator of relatively high power (its power may lie in the range 10 kilowatts (kW) to 15 kW). Consequently, the generator gives off a large amount of heat by the Joule effect and/or by hysteresis in its magnetic portion.

It is therefore common practice for the helicopter to be provided with a system for cooling the electricity generator, e.g. by circulating oil.

Nevertheless, that technical solution is not very satisfactory. Cooling the generator by means of oil increases the complexity, the cost, and the weight of the helicopter, to the detriment of its performance.

At least in the field of helicopters, there therefore exists a need for a device as mentioned above, in which the cooling system is lighter in weight and simpler than the oil circulation systems that are presently in use.

More generally, the object of the invention is thus to propose a device of the type mentioned in the introduction, in which an electricity generator delivers electricity to a rotor referred to as the “first” rotor, and has a cooling system that is simple, reliable, and lightweight, while also being highly effective for discharging the heat produced by the electricity generator.

This object is achieved by the facts that in the device, the electricity generator is arranged in a chamber arranged inside the first rotor; and that the cooling system comprises a circuit for circulating a two-phase cooling fluid, the circuit connecting an evaporator that is thermally coupled to the electricity generator to a condenser that is suitable for discharging heat to the medium outside the first rotor.

Specifically, the circuit for circulating a two-phase fluid with a condenser and an evaporator constitutes means that are relatively simple and light in weight for providing a cooling system.

The term “two-phase cooling fluid” is used to mean a fluid that can vaporize and condense so as to exchange heat and perform the heat transfer function that is expected of a cooling fluid.

The use of a cooling system that transfers heat by means of a cooling fluid (generally other than air) makes it possible in general, but not necessarily, to transfer a larger quantity of heat per unit time in a manner that is totally passive (i.e. without any moving parts) than would be possible if heat transfer relied solely on conduction without movement of fluid.

Furthermore, the combined use of a condenser and of an evaporator serves to further improve performance in terms of heat transfer power. Specifically, and advantageously in the cooling system of the invention, the changes of state of the cooling fluid are used to increase the quantity of heat that is transferred by the cooling system.

The term “evaporator” is used herein to mean a heat exchanger in which the cooling fluid receives heat and absorbs it, in particular by the fluid vaporizing.

The term “condenser” is used herein to mean a heat exchanger in which the cooling fluid delivers that heat, in particular by the fluid condensing.

The fact that the device is thermally coupled to the evaporator means that at least a large fraction of the heat given off by the electricity generator while it is in operation is communicated to the evaporator, and in particular at least 70% of the heat given off is communicated.

Thus, in the cooling system of the invention, the fluid receives heat in the evaporator and vaporizes; it then flows, while in the vapor phase, to the condenser where it releases the heat it has stored by condensing; it then returns, while in the liquid phase, to the evaporator.

An important advantage of the device of the invention is that the means for delivering electricity to the rotor are particularly compact since the generator is situated in a chamber arranged inside the rotor itself.

This arrangement is made possible by the above-described cooling system, which discharges the heat given off by the generator and thus ensures that the temperature reached by the internal members of the generator does not exceed an acceptable maximum value.

The evaporator and the condenser may be arranged relative to the first rotor in various ways.

Preferably, the evaporator and/or the condenser is/are rotary, and form(s) part of the first rotor. Thus, the condenser may be arranged so as to have an outside surface that is in direct contact with the air (or fluid) surrounding the rotor. This arrangement thus enables the condenser to act effectively to discharge the heat brought in by the fluid by communicating that heat directly to the fluid surrounding the rotor.

In an embodiment, the evaporator is likewise rotary and likewise part of the first rotor. By way of example, the evaporator may then be fastened to a rotary portion of the generator that is constrained to rotate with the first rotor. The advantage of this arrangement is that it makes it simple to make the cooling fluid circulation circuit connecting the evaporator to the condenser.

The entire cooling system can thus be rotary, forming part of the first rotor.

In certain embodiments, the first rotor may reach relatively high speeds of rotation. In order to reduce the stresses to which the cooling system is subjected, it is preferable for at least the condenser and/or the evaporator to be arranged in axisymmetric manner relative to the axis of rotation of the first rotor.

In an embodiment, when the cooling system as a whole is rotary, forming part of the first rotor, the first rotor has a tubular portion containing the chamber; and the cooling system, and possibly also a rotor of the electricity generator is/are fastened in such a manner as to be capable of being extracted via an end of the tubular portion.

Preferably, the cooling system, and possibly the rotor of the generator, is/are mechanically fastened solely to the end of the tubular portion (without any other mechanical connection): they can thus be separated relatively easily from this end of the tubular portion.

In an embodiment, the generator is arranged in axisymmetric manner on the axis of rotation of the first rotor.

It may be surrounded by the evaporator so as to provide thermal coupling between the generator and the evaporator.

In an embodiment, the generator and the cooling system are not in contact with a circumferential wall of the chamber.

In an embodiment, in order to provide thermal coupling between the generator and the evaporator, the evaporator includes at least one fluid circulation duct, in particular shaped as a loop of a coil, passing inside the electricity generator and enabling the fluid to circulate and vaporize. The passage of the fluid inside the generator itself enables heat exchange to be particularly effective between the generator and the evaporator.

Nevertheless, it is often sufficient for the fluid to flow over the periphery of the generator.

Thus, in an embodiment, the evaporator comprises at least one fluid circulation passage defined by a wall of an outer casing of the generator and enabling the fluid to circulate and vaporize. The fluid circulation passage, or preferably passages, then enable(s) the fluid to vaporize with the fluid circulating only outside the rotor of the generator.

In an embodiment, the casing presents a double wall, and the fluid circulation passage(s) is/are arranged between an inner wall and an outer wall of the casing. The term “double wall” is used herein to mean that the chamber presents two walls that are superposed in substantially parallel manner. Advantageously, this embodiment enables passages to be made in relatively simple manner in the space between the inner wall and the outer wall.

In this configuration, the cooling system preferably includes spacers arranged so as to maintain a constant distance between the two walls. These spacers may be in the form merely of studs. In a variant, at least two of the spacers are elongate, and define said passage or one of said passages.

The spacers then have two roles: they hold the walls constituting the chamber in fixed position relative to each other, and they define the fluid passages.

The casing of the generator may have various shapes.

Preferably, the casing is tubular in shape and extends along the axis of rotation of the first rotor. The term “tube” (or “tubular portion”) is used herein to mean an elongate part extending along an axis with a passage being formed on that axis. A tube may nevertheless be closed at one and/or the other of its ends. In particular, a tube may be a body of revolution, and in particular it may be cylindrical or conical.

The passage(s) may be arranged in various ways in the casing.

In an embodiment, the evaporator presents a plurality of passages parallel to an axis of the casing and distributed around its circumference. The chamber may then be fabricated in particularly simpler manner.

In a variant, the passage(s) may form a constant angle relative to the axis. They are then helical in shape, thus facilitating return of the fluid to the evaporator.

In an embodiment, the fluid circulation circuit presents a single filling orifice for filling the entire fluid circuit with fluid. This provision facilitates maintenance of the cooling system of the electricity generator.

The means for circulating the fluid in the ducts of the fluid circulation circuit between the evaporator and the condenser are described below.

These means are preferably passive, i.e. they do not include a pump. The fluid is thus set into motion by gravity, and/or by centrifugal force.

In an embodiment, the first rotor is designed to be rotated about an axis of rotation that is substantially vertical, and when in this position, the condenser is arranged above the evaporator relative to the vertical direction. Under such conditions, the liquid phase fluid condensed in the condenser moves back down by gravity into the evaporator. Therein, it is evaporated. Under the effect of the difference in density between the liquid phase and the vapor phase, the fluid vaporized in the evaporator rises spontaneously by buoyancy thrust into the condenser. Thus, the circulation of the fluid is maintained spontaneously merely because of the changes of state of the fluid in the condenser and the evaporator.

The ducts connecting the evaporator and the condenser together are preferably made in such a manner that when the fluid flows from the condenser to the evaporator, it always moves downwards. Thus, this means that the ducts arranged between the evaporator and the condenser do not present any bends that would require the fluid to rise. This arrangement avoids pockets of liquid forming that might be retained in the ducts.

In a variant, the condenser and the evaporator are arranged so as to be radially offset relative to each other, the evaporator being formed at a radial distance from the axis of rotation that is greater than the radial distance at which the condenser is arranged. Centrifugal force is thus used to encourage circulation of the fluid in the cooling system.

The condenser and the evaporator may in particular be bodies of revolution. For example they may be cylindrical bodies presenting diameters which are different one from the other.

Specifically, when the cooling system is set into rotation, centrifugal force tends to urge the fluid in the liquid phase into the larger diameter portions of the system and thus into the evaporator. Under the effect of the pressure of the fluid in the liquid phase, fluid in the vapor phase is constrained to flow in the opposite direction and go to the condenser. The fluid is thus caused to circulate in the cooling system.

Preferably, the ducts connecting the evaporator and the condenser are made in such a manner that when the fluid flows from the condenser to the evaporator, it always travels radially in the same direction and either moves continuously away from the axis or remains at a constant distance therefrom. This arrangement avoids pockets of liquid forming that might be retained in the ducts.

An embodiment of the cooling system enabling the cooling system to operate in this way (i.e. with the fluid being circulated under the effect of the cooling system rotating) consists in arranging the duct(s) connecting the evaporator to the condenser (and possibly the fluid flow passage(s) of the evaporator) on a surface that is substantially conical. This is a surface in the mathematical sense, and is not necessarily a real surface. The fluid can flow in a tube shaped as a coil.

In this embodiment, when the chamber is driven in rotation, then, under the effect of centrifugal force, the fluid in the liquid phase accumulates in the larger diameter end of the fluid circulation circuit. The fluid evaporator is naturally arranged at this end of the fluid circulation circuit.

The electricity generated by the electricity generator may be produced in various ways. It may be produced in particular by taking advantage of a speed difference between two coaxial rotors.

Thus, in an embodiment, the device also has a second rotor, the first and second rotors rotating relative to the structure of the device at mutually different respective speeds of rotation; the electricity generator presents a mode of operation in which it produces electricity by the second rotor rotating relative to the first rotor. This arrangement is advantageous particularly when the second rotor presents a speed of rotation that is high relative to that of the first rotor.

By way of example, the generator may be arranged in such a manner that the second rotor is coaxial with the first rotor and is arranged inside it, a portion of the generator then forming a portion of the second rotor.

Finally, the invention also provides a method for cooling an electricity generator for delivering electricity to a first rotor, the first rotor being suitable for being rotated relative to a stationary structure, wherein the electricity generator is placed in a chamber arranged inside the first rotor, the method comprising the following steps:

a) transferring heat produced by the generator to a cooling fluid, thereby vaporizing the fluid in an evaporator;

b) transporting the vaporized fluid to a condenser; and

c) condensing the fluid in the condenser, the heat delivered by the fluid being transmitted to the air surrounding the condenser.

The above cooling method may be performed in particular by arranging the condenser higher than the evaporator, and in particular above the evaporator, so as to enable the fluid that has condensed in the condenser to return to the evaporator merely under gravity.

In an implementation, the heat transfer step a) is performed in a rotary evaporator forming part of the first rotor.

In an implementation, the fluid condensation step c) is performed in a rotary condenser forming part of the first rotor.

The invention can be well understood and its advantages appear better on reading the following detailed description of embodiments given as non-limiting examples. The description refers to the accompanying drawings, in which:

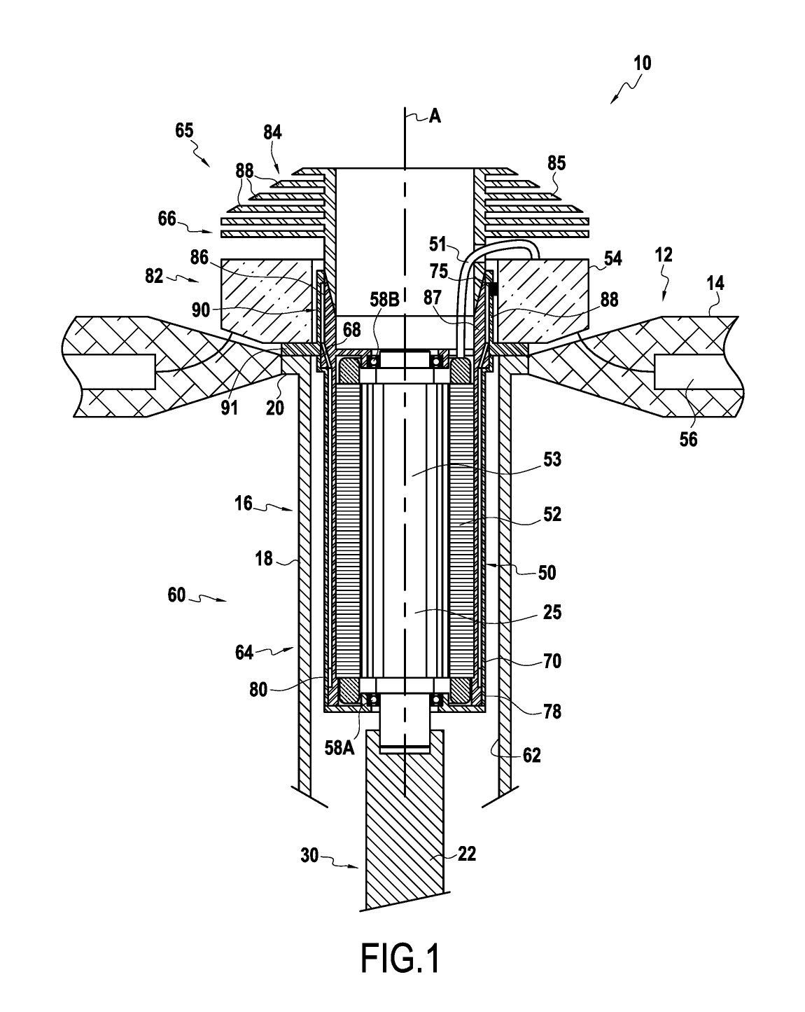

FIG. 1 is a fragmentary diagrammatic view of the rotary wing of a helicopter in accordance with the invention;

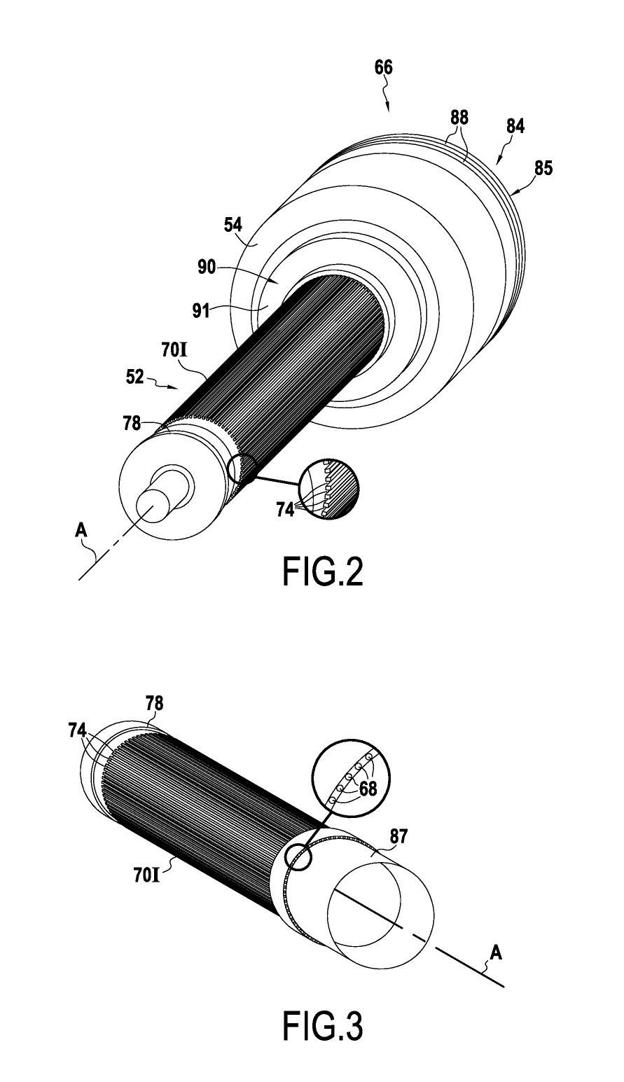

FIG. 2 is a fragmentary perspective view of the cooling system incorporated in the FIG. 1 helicopter rotor;

FIG. 3 is another fragmentary perspective view of the cooling system incorporated in the FIG. 1 helicopter rotor;

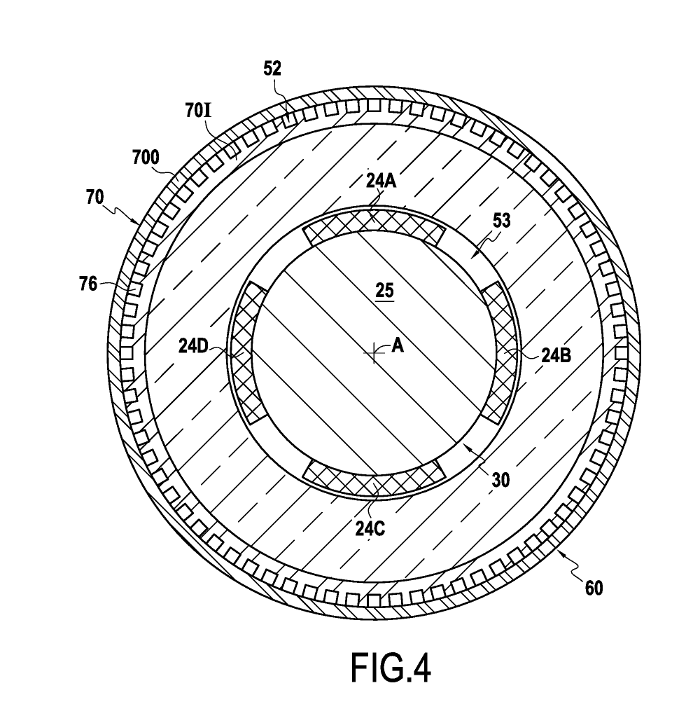

FIG. 4 is an axial section view of the cooling system and of the electricity generator incorporated in the FIG. 1 helicopter rotor; and

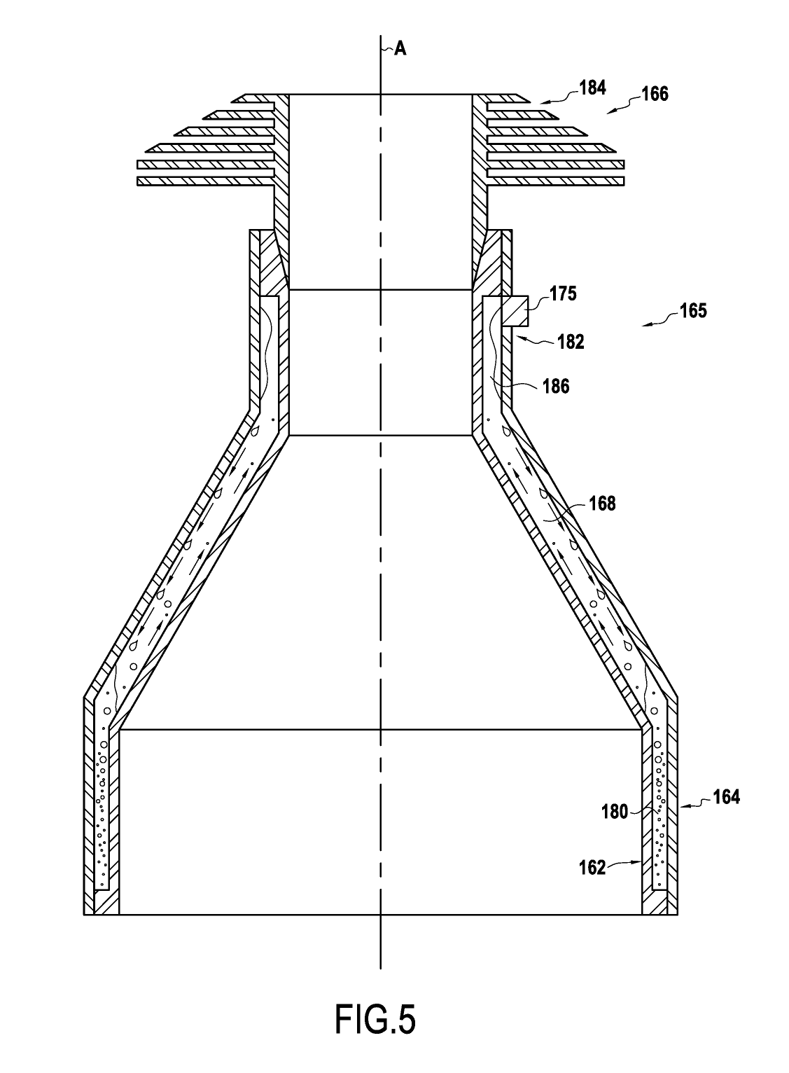

FIG. 5 is a diagrammatic longitudinal section view of a cooling system fitted to a helicopter in a second embodiment of the invention.

With reference to FIGS. 1 to 4, there follows a description of a helicopter 10 having a cooling system in a first embodiment of the invention.

The helicopter 10 has a cabin (not shown) supported in flight by a rotary wing 12. The rotary wing is constituted by a set of blades 14 fastened to the periphery of a hub 16.

The hub 16 is constituted mainly by two integrally-formed portions, namely a tubular shaft 18 and a fastener flange 20. The hub 16 is generally cylindrical in shape, being defined about an axis of rotation A that is normally vertically directed.

The rotary wing 12 is driven in rotation as follows: The outlet shaft of the helicopter engine (not shown) drives the shaft 18 of the hub 16 in rotation via a mechanical transmission. The hub 16 then transmits rotary motion to the blades 14. In flight, the speed of rotation of the rotary wing 12 is of the order of a few hundreds of revolutions per minute.

In parallel, the mechanical transmission also drives a second outlet shaft 22 in rotation about the axis A, which second shaft is coaxial with the shaft 18 and located inside it. In flight, the speed of rotation of the shaft 22 is of the order of several thousands of revolutions per minute.

Conventionally, the term “first rotor” (60) is used below to designate those parts of the helicopter that are connected to the shaft 18, for rotating at relatively low speed, and the term “second rotor” (30) is used to designate those parts that are connected to the shaft 22 for rotating at relatively high speed. The speeds of rotation are measured relative to the cabin of the helicopter, which constitutes its “stationary” structure.

The difference in speeds of rotation between the shafts 18 and 22 enables electricity to be generated by means of an electricity generator 50.

The generator is located inside the shaft 18 which constitutes a “tubular portion” in the meaning of the invention.

The generator 50 is constituted:
by a stator portion 52 forming a portion of the first rotor 60, being constituted by a set of windings arranged around a body of ferromagnetic material (in practice, such bodies are laminated, being made of laminations of ferromagnetic material);
by a rotor portion 53 forming part of the rotor 30 comprising an axial core 25 made of steel fastened in line with the drive shaft 22, and four permanent magnets 24A, 24B, 24C, and 24D; and
by a casing 70 constrained to rotate with the stator portion 52, and having functions that are specified below.

The “stator” portion 52 is named as such since its speed of rotation is much slower than the speed of rotation of the rotor portion 53.

When the second rotor 30 is driven in rotation relative to the first rotor 60, the generator 50 produces electricity. This electricity is delivered by electric wires 51 to an electricity distribution unit 54.

The electricity distribution unit 54 serves to distribute the electricity produced by the generator 50 to heater resistance elements 56 arranged in the blades 14.

When atmospheric conditions lead to a layer of ice forming on the blades, the generator 50 is used to produce electricity. This electricity is distributed to the resistance elements 56. Under the effect of this electricity, the resistance elements 56 heat by the Joule effect; and the heating produced serves to melt an undesirable layer of ice on the blades 14, or to prevent such a layer forming.

The first and second rotors 60 and 30 are held in position relative to each other and are able to rotate relative to each other by two ball bearings 58A and 58B. These are located respectively at the bottom end and at the top end of the generator 50.

Furthermore, the generator is arranged inside the shaft 18. The inside cavity of this shaft constitutes a chamber or cavity 62 of cylindrical shape.

Since the generator 50 is located inside this confined space, it is difficult to discharge the heat it gives off in operation (several hundred watts).

The presence of a heat sink system is thus absolutely essential.

In the helicopter 10, the heat discharge system is constituted by a cooling system 65 incorporated in the first rotor 60 and constrained entirely to rotate therewith. This cooling system 65 comprises two main components: an evaporator 64 and a condenser 66 that are connected by ducts 68 so as to constitute a circulation circuit for a cooling fluid.

The evaporator 64 serves to absorb heat given off by the generator 50. For this purpose, it is arranged around the generator, in the thickness of its cylindrical casing 70.

The casing 70 is made of a heat-conductive material, e.g. of aluminum, so as to enable the evaporator to be thermally coupled with the electricity generator and absorb the heat it gives off.

The casing 70 thus presents a double wall, namely an inner wall 70I and an outer wall 70O. The two walls 70I and 70O are cylindrical and coaxial about the axis A. The inside diameter of the wall 70I is substantially equal to the outside diameter of the stator portion 52 so as to minimize thermal resistance at the interface between the casing 70 and the stator portion 52.

The two walls 70I and 70O are held apart at a constant distance from each other by elongate straight splines 74 that constitute spacers in the meaning of the invention. These splines are made on the outside surface of the inner wall 70I of the casing 70. The wall 70O is not formed integrally with the inner wall 70I, but is formed separately and assembled thereto as an interference fit. This design leads to arranging multiple passages 76 between the splines 74 and parallel to the axis A. These passages extend substantially upwards along the evaporator 64 (when the helicopter is in its normal position).

In its bottom portion, the inner wall 70I presents an outer circumferential annular shoulder 78. The splines 74 end axially (relative to the axis A) at a certain distance from the shoulder. Consequently, when the outer wall 70O is fitted on the inner wall 70I, an annular enclosure 80 is formed at the bottom of the casing 70 between the shoulder 78 and the splines 74.

At the top end of the evaporator 64, the various fluid passages 76 are connected to respective fluid exchange ducts 68 that enable fluid to be exchanged with the condenser 66.

These ducts 68 are formed in the thickness of the top portion of the casing 70, which extends above the generator 50.

The function of the condenser 66 is to enable the heat picked up from the generator 50 by the fluid flowing in the evaporator 64 to be discharged to the outside of the helicopter 10. For this purpose, the condenser 66 has a condensation portion 82 connected to a radiator 84.

The condensation portion 82 is in the form of a segment of cylindrical tube about the axis A. An annular condensation enclosure 86 is arranged in the thickness of the condensation portion 82.

This enclosure 86 is formed between two concentric cylindrical walls: the inner wall 87, constituted by the top end of the casing 70, and an outer wall 88, formed by a holder part 90.

The holder part 90 comprises the cylindrical wall 88 in which the enclosure 86 is formed. It is fastened to the first rotor 60 via a flange 91 that is bolted to the flange 20.

The radiator 84 is mushroom-shaped, having a cap 85 presently multiple cooling fins 88. The plane of the cap 85 is perpendicular to the axis A of the first rotor 60.

The radiator 84 and the casing 70 of the generator 50 are fastened to the holder part 90. The casing 70 is also rigidly fastened to the stator portion 52 of the generator 50.

Consequently, the cooling system 65 as a whole (i.e. the evaporator 64, the condenser 66, and the ducts 68 formed in the top portion of the casing 70) is fastened to the flange 20 via the holder part 90.

In this way, and advantageously, in order to maintain this equipment, it is possible to extract it as a whole from the shaft 18 of the helicopter 10, by extracting the equipment upwards from the shaft 18 along the axis A after separating the holder part 90 from the flange 20.

It is thus particularly simple to maintain the generator 50 and/or the cooling system 65. In addition, the cooling system 65 is filled with cooling fluid via a single orifice 75.

This orifice is arranged in the outer wall 87 of the condensation portion 82.

The cooling system 65 operates as follows.

While the helicopter is in operation, with its rotary wing rotating, the generator 50 gives off heat, which is communicated to the casing 70 by conduction.

The annular enclosures 80 and 86 and the passages 76 are filled with cooling fluid, specifically acetone. The cooling fluid is selected so that its vaporization temperature is compatible with the temperature ranges that are likely to be encountered by the generator and by the radiator while the helicopter is in operation.

When the generator 50 is in operation and delivering electricity, the temperature in the chamber 72 rises. Under the effect of heat, the fluid vaporizes in the enclosure 80 and the passages 76. The density difference between the fluid in the liquid state and in the gaseous state then suffices for the fluid in the gaseous phase, as vaporized in the evaporator 64, to move spontaneously along the passages 76 and the ducts 68 in order to reach the annular enclosure 86.

This enclosure remains at a temperature that is relatively low because the cooling fins 88 are cooled continuously on contact with the air being moved by the blades of the helicopter. The temperature of the radiator thus remains relatively temperate, and by conduction the same applies to the condensation portion 82. Consequently, the fluid that arrives in the vapor phase in the enclosure 86 condenses inside the enclosure. The liquid fluid then moves back down merely under gravity, via the ducts 68 and the passages 76 to the enclosure 80.

It can be understood that the movement of the fluid in the cooling system 65 is self-sustaining. This movement advantageously enables a very large quantity of heat to be discharged from the generator per unit of time.

FIG. 5 shows another embodiment of the invention. This shows an embodiment of the invention in which centrifugal force is used to cause fluid to circulate in the cooling system.

In this figure, elements that are identical or similar to corresponding elements in the first embodiment are given the same references as those elements, plus 100.

FIG. 5 shows a cooling system 165 comprising an evaporator 164 and a condenser 166, connected together by ducts 168.

The evaporator 164 is in the form of a cylindrical tube segment about the axis A. Its wall has an annular evaporation enclosure 180 formed therein, where the fluid is vaporized. The inner wall of the evaporator 164 (or of the enclosure 180) defines a cylindrical chamber 162 formed inside the evaporator 164.

An electricity generator (not shown) analogous to the generator 50 is arranged in the chamber 162.

The condenser 166 is realized in a manner very similar to the condenser 66, with a condensation portion 182 having a wall that contains an annular condensation chamber 186 and that is connected to a finned radiator 184.

The cooling system 165 operates similarly to the cooling system 65.

In operation, the entire cooling system, together with the electricity generator, is set into rotation about the axis A.

The only difference in the operation of the cooling system 165 compared with the cooling system 65 relates to causing the fluid to circulate.

Specifically, in the cooling system 165, the fluid is circulated by centrifugal force:

When the cooling system 165 is driven in rotation, centrifugal forces act on the fluid filling the enclosures 180 and 186, and the ducts 168. Since the fluid in the liquid phase has greater density than the fluid in the gaseous phase, the liquid phase fluid tends to return to the evaporator; as a result, the gaseous phase fluid tends to return to the condenser. These two movements thus sustain spontaneous circulation of the fluid in the cooling system 165.

Circulation of the fluid is made easier by the fact that the ducts 168 are rectilinear ducts, connecting together the respective peripheries of the enclosures 180 and 186. The ducts 168 are thus formed on the surface of a conical surface. Since they are rectilinear, the fluid flowing from the condenser to the evaporator moves with increasing distance from the axis A. This serves to avoid pockets of retained fluid being formed.

1. A method for cooling an electricity generator for delivering electricity to a first rotor, the first rotor being suitable for being rotated relative to a stationary structure, the electricity generator being arranged in a chamber arranged inside the first rotor, wherein the method comprises the following steps:
a) transferring heat produced by the generator to a cooling fluid, thereby vaporizing the fluid in an evaporator;
b) transporting the vaporized fluid to a condenser;
and
c) condensing the fluid in the condenser, the heat delivered by the fluid being transmitted to the air surrounding the condenser.

2. A cooling method according to claim 1, wherein the heat transfer step a) is performed in a rotary evaporator forming part of the first rotor, and/or the fluid condensation step c) is performed in a rotary condenser forming part of the first rotor.

3. A device comprising a stationary structure, a first rotor suitable for being rotated relative to the stationary structure, an electricity generator for delivering electricity to the first rotor, and a cooling system for discharging the heat produced by the electricity generator; wherein the electricity generator is arranged in a chamber arranged inside the first rotor, and the cooling system comprises a circuit for circulating a two-phase cooling fluid, the circuit connecting an evaporator that is thermally coupled to the electricity generator to a condenser that is suitable for discharging heat to the medium outside the first rotor.

4. A device according to claim 3, wherein the evaporator and/or the condenser is/are rotary, and form(s) part of the first rotor.

5. A device according to claim 3, wherein the condenser and the evaporator are arranged so as to be radially offset relative to each other, the evaporator being formed at a radial distance from the axis of rotation that is greater than the radial distance at which the condenser is arranged.

6. A device according to claim 3, where the cooling system as a whole is rotary, forming part of the first rotor, wherein the first rotor has a tubular portion containing the chamber; and the cooling system, and possibly also a rotor of the electricity generator, is/are fastened in such a manner as to be capable of being extracted via an end of said tubular portion.

7. A device according to claim 3, wherein the electricity generator and the cooling system are not in contact with a circumferential wall of the chamber.

8. A device according to claim 3, wherein the evaporator includes at least one fluid circulation duct, in particular shaped as a loop of a coil, passing inside the electricity generator and enabling the fluid to circulate and vaporize.

9. A device according to claim 3,
wherein the evaporator comprises at least one fluid circulation passage defined by a wall of an outer
casing of the generator and enabling the fluid to circulate and vaporize.

10. A device according to claim 9, wherein the casing presents a double wall, and said at least one passage is arranged between an inner wall and an outer wall of the casing.

11. A device according to claim 9, wherein the evaporator presents a plurality of passages parallel to an axis of the casing and distributed around its circumference.

12. A device according to claim 3, wherein the first rotor is designed to be rotated about an axis of rotation that is substantially vertical, and when in this position, the condenser is arranged above the evaporator relative to the vertical direction.

13. A device according to claim 3, wherein the electricity generator presents a mode of operation in which it produces electricity by rotation of a second rotor relative to the first rotor, and the first and second rotors rotate relative to the structure at respective different speeds of rotation.

14. A device according to claim 13, wherein the second rotor is coaxial with the first rotor and arranged inside it, a portion of the generator forming a portion of the second rotor.

15. A device according to claim 3, having its fluid circulation circuit presenting a single filling orifice for filling the entire fluid circuit
with fluid.
